(19) United States
(12) Patent Application Publication
(10) Pub. No.: US 2022/0288751 A1
(43) Pub. Date: Sep. 15, 2022

(54) Socket with Engaging Structure

(71) Applicant: KABO Tool Company, Taichung City (TW)

(72) Inventor: Chih-Ching Hsieh, Taichung City (TW)

(21) Appl. No.: 17/652,364

(22) Filed: Feb. 24, 2022

(30) Foreign Application Priority Data
Mar. 11, 2021 (TW) 110108789

(51) Int. Cl. B25B 23/00; B25B 13/06

(52) U.S. Cl. CPC B25B 23/0035; B25B 13/06

(57) ABSTRACT

A socket with an engaging structure includes a socket body, an opening, a groove, and a stop ring. The socket body has a central axis. The opening is formed at an end of the socket body. The groove is disposed in, and along the circumference of, the inner side of the socket body. The stop ring is disposed in the groove and includes at least one hollow cavity, at least one inner surface, and an outer surface. The inner surface surrounds the hollow cavity, and the outer surface is farther away from the hollow cavity than is the inner surface. The socket is configured to reduce abrasion between the socket body and a tool member and decrease the difficulty of bringing the tool member into engagement in the socket.

### BACKGROUND OF THE INVENTION

### 1. Technical Field

The present disclosure relates to a socket and more particularly to a socket with an engaging structure.

### 2. Description of Related Art

The market has been supplied with a good number of sockets that can be operated with ease. Some of the conventional sockets have a stop ring for engaging with a tool member, but after being pressed and abraded by a tool member repeatedly for a long time, the stop ring may be permanently deformed and hence no longer good for use.

In view of this, it has been a goal for those in the socket-related industries to develop a socket that not only has a stop-ring-based engaging structure, but also can reduce abrasion between the stop ring and a tool member and thereby extend the service life of the stop ring.

### BRIEF SUMMARY OF THE INVENTION

One objective of the present disclosure is to provide a socket having an engaging structure. The engaging structure is formed by disposing a stop ring in a groove, and the stop ring has a hollow cavity that provides a space into which the stop ring can collapse, thereby reducing abrasion between the socket body and a tool member and decreasing the difficulty of bringing the tool member into engagement in the socket.

According to an embodiment of the present disclosure, a socket with an engaging structure includes a socket body, an opening, at least one groove, and at least one stop spring. The socket body has a central axis. The opening is formed at one end of the socket body. The groove is disposed in, and along the circumference of, the inner side of the socket body. The stop ring is disposed in the groove and includes at least one hollow cavity, at least one inner surface, and an outer surface. The inner surface surrounds the hollow cavity, and the outer surface is farther away from the hollow cavity than is the inner surface.

When the stop ring is pressed and deformed by a tool member, the hollow cavity provides a deformation space into which the stop ring can collapse, so the stress the stop ring is subjected to when engaged with the tool member is reduced. Consequently, abrasion between the socket and the tool member is reduced, and so is the difficulty of bringing the tool member into engagement in the socket.

In the socket with the engaging structure according to the foregoing embodiment, the number of the at least one stop ring may be two.

In the socket with the engaging structure according to the foregoing embodiment, the stop ring may further include a plurality of protruding structures that are protrudingly disposed on the outer surface of the stop ring.

In the socket with the engaging structure according to the foregoing embodiment, the stop ring may have a wavy shape.

In the socket with the engaging structure according to the foregoing embodiment, the stop ring may have a polygonal cross section.

In the socket with the engaging structure according to the foregoing embodiment, the hollow cavity may have a polygonal cross section, and the cross section of the hollow cavity may correspond to the cross section of the stop ring.

In the socket with the engaging structure according to the foregoing embodiment, the stop ring may be a closed stop ring.

In the socket with the engaging structure according to the foregoing embodiment, the stop ring has two ends, and the stop ring surrounds the central axis of the socket body in such a way that the two ends define a reflex central angle θ satisfying the condition: 270°≤θ≤360°.

In the socket with the engaging structure according to the foregoing embodiment, the number of the at least one hollow cavity may be two.

### BRIEF DESCRIPTION OF THE SEVERAL VIEWS OF THE DRAWINGS

FIG. 1 is an exploded perspective view of the socket with an engaging structure according to the first embodiment of the present disclosure;

FIG. 2 is a sectional view of the socket with the engaging structure according to the first embodiment as shown in FIG. 1;

FIG. 3 is a sectional view of a stop ring in the first embodiment as shown in FIG. 1, taken along line 3-3 in FIG. 1;

FIG. 4 is a sectional view of a stop ring of the socket with an engaging structure according to the second embodiment of the present disclosure;

FIG. 5 is a perspective view of a stop ring of the socket with an engaging structure according to the third embodiment of the present disclosure;

FIG. 6 is a sectional view of a stop ring of the socket with an engaging structure according to the fourth embodiment of the present disclosure;

FIG. 7 is a sectional view of a stop ring of the socket with an engaging structure according to the fifth embodiment of the present disclosure;

FIG. 8 is a sectional view of a stop ring of the socket with an engaging structure according to the sixth embodiment of the present disclosure;

FIG. 9 is a sectional view of a stop ring of the socket with an engaging structure according to the seventh embodiment of the present disclosure;

FIG. 10 is an exploded perspective view of the socket with an engaging structure according to the eighth embodiment of the present disclosure; and

FIG. 11 is a sectional view of the stop ring in the eighth embodiment as shown in FIG. 10, taken along line 11-11 in FIG. 10.

### DETAILED DESCRIPTION OF THE INVENTION

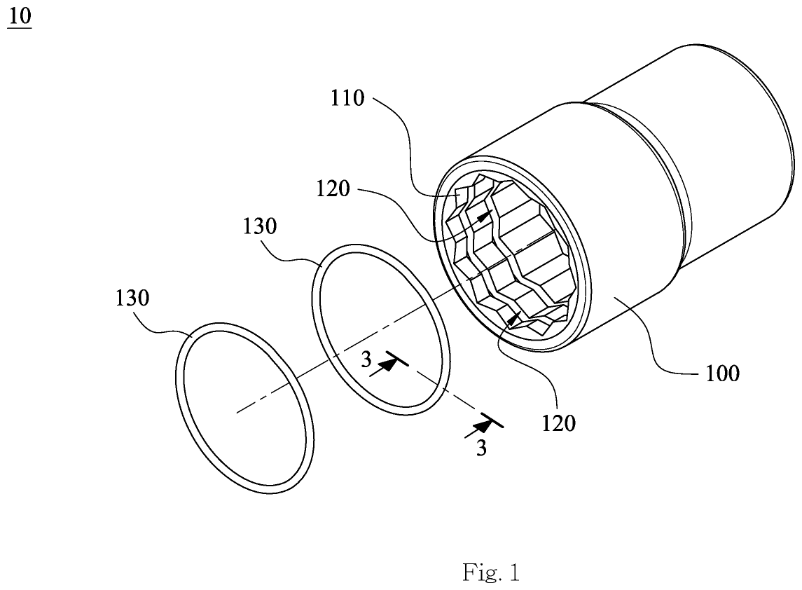

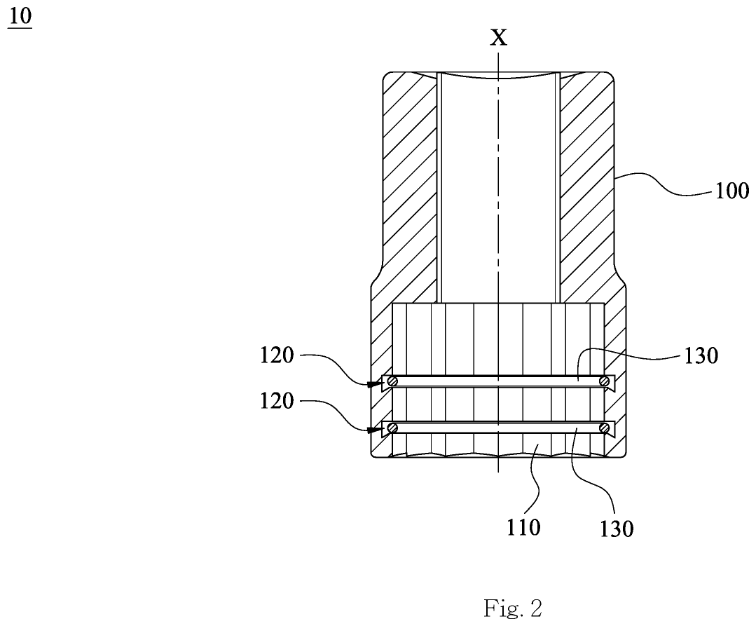

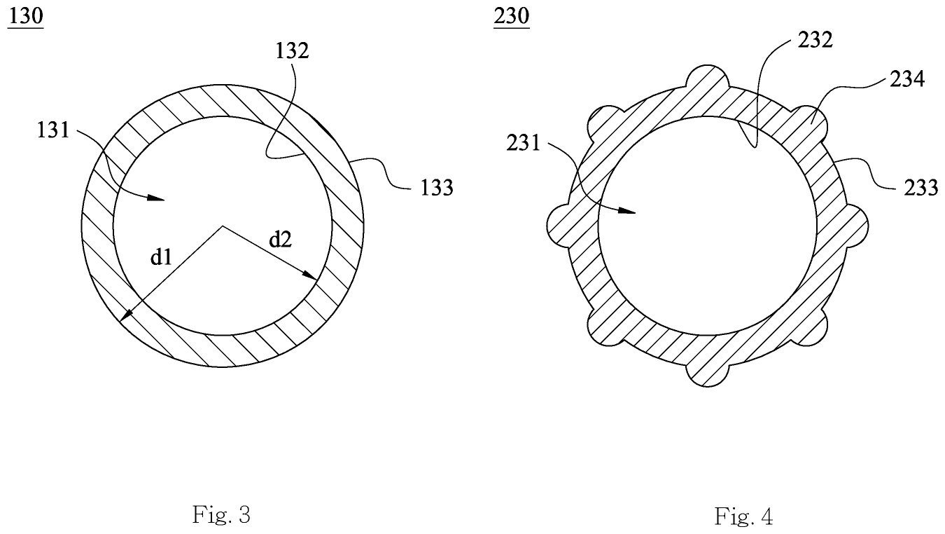

Please refer to FIG. 1 for an exploded perspective view of the socket 10 with an engaging structure according to the first embodiment of the present disclosure, FIG. 2 for a sectional view of the socket 10 with the engaging structure according to the first embodiment as shown in FIG. 1, and FIG. 3 for a sectional view of a stop ring 130 in the first embodiment as shown in FIG. 1, with the sectional view taken along line 3-3 in FIG. 1. As shown in FIG. 1 to FIG. 3, the socket 10 with the engaging structure includes a socket body 100, an opening 110, at least one groove 120, and at least one stop ring 130. The socket body 100 has a central axis X. The opening 110 is formed at one end of the socket body 100. The at least one groove 120 is disposed in, and along the circumference of, the inner side (not indicated by a reference numeral in the drawings) of the socket body 100. The at least one stop ring 130 is disposed in the at least one groove 120 and includes at least one hollow cavity 131, at least one inner surface 132, and an outer surface 133. Each inner surface 132 surrounds the corresponding hollow cavity 131, and the outer surface 133 is farther away from each hollow cavity 131 than is the corresponding inner surface 132.

The engaging structure is formed by disposing the at least one stop ring 130 in the at least one groove 120. When a tool member (not shown) is inserted into the socket body 100 through the opening 110, the at least one stop ring 130 is engaged with the tool member and is pressed and deformed by the tool member. The at least one hollow cavity 131 is so configured that the at least one stop ring 130 can collapse into the at least one hollow cavity 131 when pressed by the tool member, meaning the at least one stop ring 130 is given additional room for inward deformation so that the stress to which the at least one stop ring 130 is subjected when engaged with the tool member can be lowered to reduce abrasion of the socket body 100 and of the tool member. Furthermore, it is inevitable for the tool member to have dimensional errors within manufacturing tolerances, and the dimensional errors may result in a mismatch in dimension when the tool member is brought into engagement in the socket, making the engaging process difficult. The at least one hollow cavity 131 is designed to provide more space to facilitate engagement between the tool member and the socket body 100, to increase the mechanical tolerance of the socket 10 with the engaging structure, and to thereby reduce the difficulty of engagement attributable to dimensional errors of the tool member.

More specifically, the at least one stop ring 130 may be a closed stop ring or an open stop ring; the present disclosure has no limitation in this regard. In the first embodiment, each stop ring 130 is a closed stop ring to simplify the manufacturing process of the stop ring 130.

The at least one stop ring 130 may be made of an elastic material or metal. The present disclosure has no limitation on the material of the at least one stop ring 130. In the first embodiment, each stop ring 130 is made of an elastic material to increase the elasticity with which the stop ring 130 can engage with the tool member.

In the first embodiment, the number of the at least one groove 120 and the number of the at least one stop ring 130 are both two. The present disclosure, however, has no limitation on the aforesaid numbers. In other words, the numbers and arrangements of the at least one groove 120 and of the at least one stop ring 130 may be adjusted according to the specifications of the tool member and user needs.

Please refer to FIG. 4 for a sectional view of a stop ring 230 of the socket with an engaging structure according to the second embodiment of the present disclosure. The socket body, the opening, and the at least one groove in the second embodiment have the same structures and configuration relationship as the socket body 100, the opening 110, and the at least one groove 120 in the first embodiment and therefore will not be described repeatedly. As can be seen in FIG. 4, the stop ring 230 includes at least one hollow cavity 231, at least one inner surface 232, and an outer surface 233. The inner surface 232 surrounds the hollow cavity 231, and the outer surface 233 is farther away from the hollow cavity 231 than is the inner surface 232. This configuration helps reduce abrasion between the socket body and a tool member and decrease the difficulty of bringing the tool member into engagement in the socket.

As shown in FIG. 4, the stop ring 230 further includes a plurality of protruding structures 234, and the protruding structures 234 are protrudingly disposed on the outer surface 233. The protruding structures 234 are configured to increase the area of contact, and hence friction, between the stop ring 230 and a tool member so that the tool member can be securely engaged in the socket.

As in the first embodiment, in which there are two stop rings 130, the second embodiment includes two stop rings 230. The at least one hollow cavity 231 and the at least one inner surface 232 of each stop ring 230 are the same as the at least one hollow cavity 131 and the at least one inner surface 132 of each stop ring 130 in the first embodiment in terms of structure and number and therefore will not be described repeatedly.

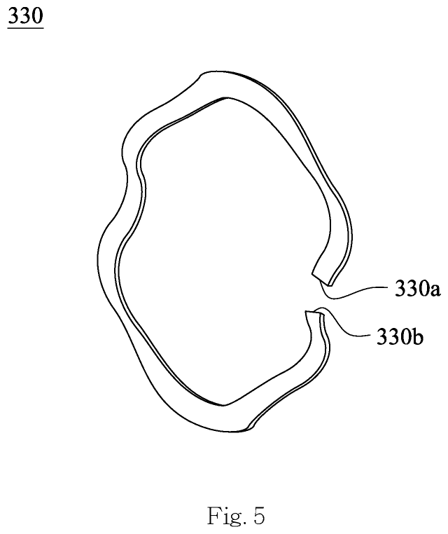

Please refer to FIG. 5 for a perspective view of a stop ring 330 of the socket with an engaging structure according to the third embodiment of the present disclosure. The socket body, the opening, and the at least one groove in the third embodiment have the same structures and configuration relationship as the socket body 100, the opening 110, and the at least one groove 120 in the first embodiment and therefore will not be described repeatedly. As shown in FIG. 5, the stop ring 330 has a wavy shape. The wavy shape is designed to prevent the stop ring 330 from getting loose due to vibrations in the environment or an external force, to reduce the stress to which the stop ring 330 is subjected, and to thereby extend the service life of the stop ring 330.

More specifically, the stop ring 330 may be made of an elastic material or metal. The present disclosure has no limitation on the material of the stop ring 330. In the third embodiment, the stop ring 330 is made of metal in order to have high wear resistance.

Moreover, the stop ring 330 may be a closed stop ring or an open stop ring; the present disclosure has no limitation in this regard. In the third embodiment, the stop ring 330 is an open stop ring. More specifically, the stop ring 330 has two ends 330a and 330b. The stop ring 330 surrounds the central axis of the socket body (not shown in FIG. 5) in such a way that the two ends 330a and 330b define a reflex central angle θ satisfying the condition: 270°≤θ≤360°. This configuration helps increase the smoothness of disposing the stop ring 330 in the corresponding groove.

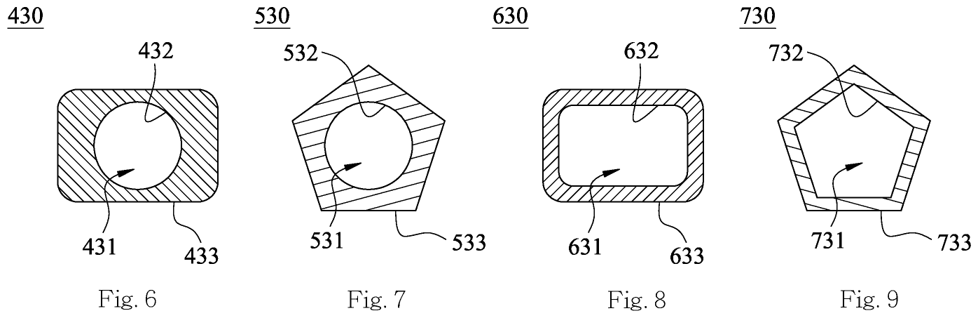

Please refer to FIG. 6 for a sectional view of a stop ring 430 of the socket with an engaging structure according to the fourth embodiment of the present disclosure. The socket body, the opening, and the at least one groove in the fourth embodiment have the same structures and configuration relationship as the socket body 100, the opening 110, and the at least one groove 120 in the first embodiment and therefore will not be described repeatedly. The stop ring 430 includes at least one hollow cavity 431, at least one inner surface 432, and an outer surface 433. The inner surface 432 surrounds the hollow cavity 431, and the outer surface 433 is farther away from the hollow cavity 431 than is the inner surface 432. This configuration helps reduce abrasion between the socket body and a tool member and decrease the difficulty of bringing the tool member into engagement in the socket.

As shown in FIG. 6, the stop ring 430 has a polygonal cross section; the present disclosure, however, has no limitation on the cross-sectional shape of the stop ring. It is worth mentioning that the cross-sectional shape of the hollow cavity 431 is different from that of the stop ring 430. In the fourth embodiment, the stop ring 430 has a rectangular cross section whereas the hollow cavity 431 has a circular cross section; the present disclosure, however, has no limitation on the shapes of those cross sections. The present disclosure allows stop rings of different shapes to be provided to meet the requirements of different tool members.

As in the first embodiment, in which there are two stop rings 130, the fourth embodiment includes two stop rings 430. The at least one hollow cavity 431 and the at least one inner surface 432 of each stop ring 430 are the same as the at least one hollow cavity 131 and the at least one inner surface 132 of each stop ring 130 in the first embodiment in terms of structure and number and therefore will not be described repeatedly.

Please refer to FIG. 7 for a sectional view of a stop ring 530 of the socket with an engaging structure according to the fifth embodiment of the present disclosure. The socket body, the opening, and the at least one groove in the fifth embodiment have the same structures and configuration relationship as the socket body 100, the opening 110, and the at least one groove 120 in the first embodiment and therefore will not be described repeatedly. The stop ring 530 includes at least one hollow cavity 531, at least one inner surface 532, and an outer surface 533. The inner surface 532 surrounds the hollow cavity 531, and the outer surface 533 is farther away from the hollow cavity 531 than is the inner surface 532. This configuration helps reduce abrasion between the socket body and a tool member and decrease the difficulty of bringing the tool member into engagement in the socket.

As shown in FIG. 7, the stop ring 530 has a polygonal cross section; the present disclosure, however, has no limitation on the cross-sectional shape of the stop ring. It is worth mentioning that the cross-sectional shape of the hollow cavity 531 is different from that of the stop ring 530. In the fifth embodiment, the stop ring 530 has a pentagonal cross section whereas the hollow cavity 531 has a circular cross section; the present disclosure, however, has no limitation on the shapes of those cross sections. The present disclosure allows stop rings of different shapes to be provided to meet the requirements of different tool members.

As in the first embodiment, in which there are two stop rings 130, the fifth embodiment includes two stop rings 530. The at least one hollow cavity 531 and the at least one inner surface 532 of each stop ring 530 are the same as the at least one hollow cavity 131 and the at least one inner surface 132 of each stop ring 130 in the first embodiment in terms of structure and number and therefore will not be described repeatedly.

Please refer to FIG. 8 for a sectional view of a stop ring 630 of the socket with an engaging structure according to the sixth embodiment of the present disclosure. The socket body, the opening, and the at least one groove in the sixth embodiment have the same structures and configuration relationship as the socket body 100, the opening 110, and the at least one groove 120 in the first embodiment and therefore will not be described repeatedly. The stop ring 630 includes at least one hollow cavity 631, at least one inner surface 632, and an outer surface 633. The inner surface 632 surrounds the hollow cavity 631, and the outer surface 633 is farther away from the hollow cavity 631 than is the inner surface 632. This configuration helps reduce abrasion between the socket body and a tool member and decrease the difficulty of bringing the tool member into engagement in the socket.

As shown in FIG. 8, the stop ring 630 has a polygonal cross section; the present disclosure, however, has no limitation on the cross-sectional shape of the stop ring. In the sixth embodiment, the stop ring 630 has a rectangular cross section. The present disclosure allows stop rings of different shapes to be provided to meet the requirements of different tool members.

The hollow cavity 631 also has a polygonal cross section, and the cross section of the hollow cavity 631 corresponds to that of the stop ring 630; the present disclosure, however, has no limitation in these regards. In the sixth embodiment, the hollow cavity 631 has a rectangular cross section corresponding to the rectangular cross section of the stop ring 630 to simplify the manufacturing process of the stop ring 630.

As in the first embodiment, in which there are two stop rings 130, the sixth embodiment includes two stop rings 630. The at least one hollow cavity 631 and the at least one inner surface 632 of each stop ring 630 are the same as the at least one hollow cavity 131 and the at least one inner surface 132 of each stop ring 130 in the first embodiment in terms of structure and number and therefore will not be described repeatedly.

Please refer to FIG. 9 for a sectional view of a stop ring 730 of the socket with an engaging structure according to the seventh embodiment of the present disclosure. The socket body, the opening, and the at least one groove in the seventh embodiment have the same structures and configuration relationship as the socket body 100, the opening 110, and the at least one groove 120 in the first embodiment and therefore will not be described repeatedly. The stop ring 730 includes at least one hollow cavity 731, at least one inner surface 732, and an outer surface 733. The inner surface 732 surrounds the hollow cavity 731, and the outer surface 733 is farther away from the hollow cavity 731 than is the inner surface 732. This configuration helps reduce abrasion between the socket body and a tool member and decrease the difficulty of bringing the tool member into engagement in the socket.

As shown in FIG. 9, the stop ring 730 has a polygonal cross section; the present disclosure, however, has no limitation on the cross-sectional shape of the stop ring. In the seventh embodiment, the stop ring 730 has a pentagonal cross section. The present disclosure allows stop rings of different shapes to be provided to meet the requirements of different tool members.

The hollow cavity 731 also has a polygonal cross section, and the cross section of the hollow cavity 731 corresponds to that of the stop ring 730; the present disclosure, however, has no limitation in these regards. In the seventh embodiment, the hollow cavity 731 has a pentagonal cross section corresponding to the pentagonal cross section of the stop ring 730 to simplify the manufacturing process of the stop ring 730.

As in the first embodiment, in which there are two stop rings 130, the seventh embodiment includes two stop rings 730. The at least one hollow cavity 731 and the at least one inner surface 732 of each stop ring 730 are the same as the at least one hollow cavity 131 and the at least one inner surface 132 of each stop ring 130 in the first embodiment in terms of structure and number and therefore will not be described repeatedly.

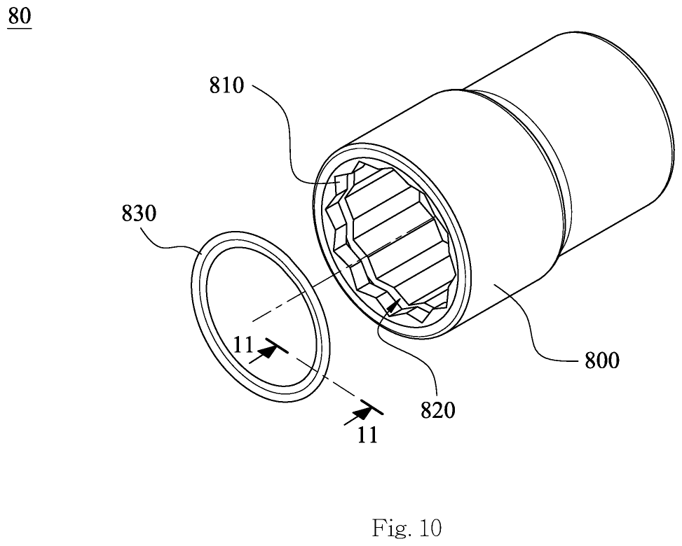

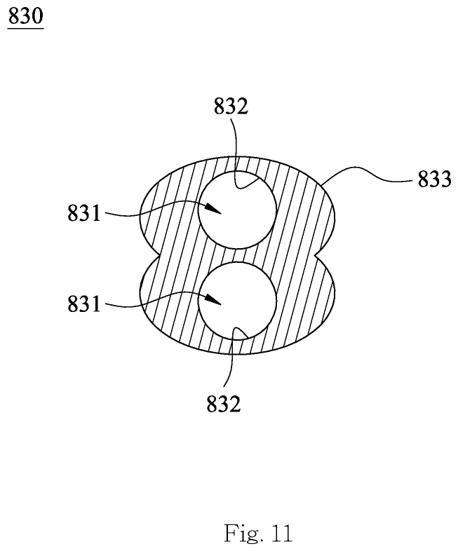

Please refer to FIG. 10 for an exploded perspective view of the socket 80 with an engaging structure according to the eighth embodiment of the present disclosure. The socket 80 with the engaging structure includes a socket body 800, an opening 810, at least one groove 820, and at least one stop ring 830. The socket body 800, the opening 810, and the at least one groove 820 in the eighth embodiment are different from the socket body 100, the opening 110, and the at least one groove 120 in the first embodiment only in that the number of the at least one groove 820 is one. The structures and configuration relationship of the aforesaid components in the two embodiments are the same.

Please refer to FIG. 11 for a sectional view of the stop ring 830 in the eighth embodiment as shown in FIG. 10, with the sectional view taken along line 11-11 in FIG. 10. In the eighth embodiment, the number of the at least one stop ring 830 is one, and the stop ring 830 is disposed in the groove 820. As shown in FIG. 11, the stop ring 830 includes at least one hollow cavity 831, at least one inner surface 832, and an outer surface 833. Each inner surface 832 surrounds the corresponding hollow cavity 831, and the outer surface 833 is farther away from the each hollow cavity 831 than is the corresponding inner surface 832. This configuration helps reduce abrasion between the socket body 800 and a tool member and decrease the difficulty of bringing the tool member into engagement in the socket 80.

As shown in FIG. 11, the number of the at least one hollow cavity 831 and the number of the at least one inner surface 832 are both two, and each hollow cavity 831 is surrounded by the corresponding inner surface 832. The present disclosure, however, has no limitation on the number of the at least one hollow cavity 831 or the number of the at least one inner surface 832. The hollow cavities 831 are configured to provide the stop ring 830 with more deformation spaces than in the previous embodiments and help reduce the material used to make the stop ring 830.

The technical features (e.g., number and structure) of the stop ring(s) in the first to the eighth embodiments of the present disclosure may be combined as needed to meet the requirements of different sockets and produce the corresponding effects.

According to the above, the disclosed socket with an engaging structure has the following advantages: 1) The configuration of the at least one hollow cavity helps reduce abrasion between the socket body and a tool member and decrease the difficulty of bringing the tool member into engagement in the socket; 2) the shape of the at least one stop ring may be changed (e.g., into a polygon such as a pentagon) according to user needs; and 3) the at least one hollow cavity of the at least one stop ring helps reduce the amount of the material required to make the at least one stop ring.

While the invention claimed by the applicant has been disclosed through the embodiments described above, those embodiments are not intended to be restrictive of the scope of the invention. A person skilled in the art shall be able to make various changes and modifications to the embodiments without departing from the spirit or scope of the invention. The scope of the patent protection sought by the applicant is defined by the appended claims.

What is claimed is:

1. A socket with an engaging structure, comprising:
a socket body having a central axis;
an opening formed at an end of the socket body;
at least one groove disposed in, and along a circumference of, an inner side of the socket body; and
at least one stop ring disposed in the at least one groove and comprising:
at least one hollow cavity;
at least one inner surface each surrounding a corresponding one of the at least one hollow cavity; and
an outer surface, wherein the outer surface is farther away from each of the at least one hollow cavity than is a corresponding one of the at least one inner surface.

2. The socket with the engaging structure as claimed in claim 1, wherein the number of the at least one stop ring is two.

3. The socket with the engaging structure as claimed in claim 1, wherein the at least one stop ring further comprises a plurality of protruding structures protrudingly disposed on the outer surface.

4. The socket with the engaging structure as claimed in claim 1, wherein the at least one stop ring is of a wavy shape.

5. The socket with the engaging structure as claimed in claim 1, wherein the at least one stop ring has a polygonal cross section.

6. The socket with the engaging structure as claimed in claim 5, wherein the at least one hollow cavity has a polygonal cross section, and the cross section of the at least one hollow cavity corresponds to the cross section of the at least one stop ring.

7. The socket with the engaging structure as claimed in claim 1, wherein the at least one stop ring is a closed stop ring.

8. The socket with the engaging structure as claimed in claim 1, wherein the at least one stop ring has two ends and surrounds the central axis of the socket body in such a way that the two ends define a reflex central angle θ satisfying the condition: 270°≤θ≤360°.

9. The socket with the engaging structure as claimed in claim 1, wherein the number of the at least one hollow cavity is two.
